(19) United States
(12) Patent Application Publication
(10) Pub. No.: US 2007/0182940 A1
(43) Pub. Date: Aug. 9, 2007

(54) PROJECTION DISPLAY APPARATUS

(76) Inventor: Hiromi Asai, Tochigi-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/671,504

(22) Filed: Feb. 6, 2007

(30) Foreign Application Priority Data
Feb. 9, 2006 (JP) 2006-032688

(51) Int. Cl. G03B 21/14; G03B 3/00

(52) U.S. Cl. 353/101

(57) ABSTRACT

A projection display apparatus is provided with a control unit that drives a focus lens included in a projection lens based on outputs from a focus sensor and a temperature sensor. The control unit provided in the projection display apparatus compensates the output value of the temperature sensor according to the amount of change in the output value of the temperature sensor with time and drives the focus lens using the value thus compensated.

### BACKGROUND OF THE INVENTION

1. Field of the Invention

The present invention relates to a projection display apparatus.

2. Description of the Related Art

There has been developed a technique concerning projectors in which an image projected on a screen is picked up into an AF (auto focus) sensor, information on the distance to the screen (distance information) is obtained from the output of the sensor, and focusing is performed by the projection lens based on that information. In this case, the AF sensor has two line sensors, and one of the image data taken into the line sensors is compared with the other image data to determine difference between those data, and distance information is obtained from the difference. As is known, optical characteristics of the projection lens change depending on the temperature. This means that even when the difference obtained by the AF sensor is the same, the defocus amount of the projection lens varies if the temperature of the projection lens varies. In view of this, temperature compensation processing is generally performed on the output value of the AF sensor based on the output value of the temperature sensor that correlates with the AF sensor.

However, the projector is likely to be subjected to heat generated by a strong lamp that serves as a light source. Consequently, it is difficult to determine the relationship between the output value of the AF sensor and the output value of the temperature sensor in some situations in which the projector is used. This sometimes disables accurate temperature compensation processing. For example, if the power of a projector is turned off and then turned on again after a while before it has cooled sufficiently, there may sometimes be a difference between the temperature of the AF sensor and the temperature of the temperature sensor due to a rapid change in the temperature in the cabinet of the apparatus, as shown in FIG. 5. As a countermeasure to the above problem, a technique of enclosing the AF sensor and the temperature sensor in an air-tight casing to insulate them from heat has been devised (see for example, Japanese Patent Application Laid-Open No. 2005-233880).

However, according to the technique disclosed in Japanese Patent Application Laid-Open No. 2005-233880, it is true that accurate distance information can be obtained, but an air-tight casing is needed, which leads to an increase in the cost and complicates assembly.

### SUMMARY OF THE INVENTION

An object of the present invention is to provide a projection display apparatus in which precise auto-focusing can be performed without use of an air-tight casing.

A projection display apparatus according to an exemplary mode of the present invention comprises a projection lens that projects an image, a focus sensor, a temperature sensor and a control unit that drives a focus lens included in the projection lens based on outputs from the focus sensor and the temperature sensor. The control unit compensates the output value of the temperature sensor according to the amount of change in the output value of the temperature sensor with lapse time, and drives the focus lens using the value thus compensated.

Further features of the present invention will become apparent from the following description of exemplary embodiments with reference to the attached drawings.

### BRIEF DESCRIPTION OF THE DRAWINGS

FIG. 1 is s diagram illustrating the configuration of a liquid crystal projector.

FIG. 2 is a flow chart of an overall process of the AF operation.

FIG. 3 is a flow chart of a process of compensating the output value of a temperature sensor.

FIG. 4 is a graph illustrating relationship between determination time and temperature in the process of compensating the temperature sensor output value.

FIG. 5 is a graph illustrating time zones and compensation amounts in the process of compensating the temperature sensor output value.

FIG. 6 is a temperature sensor compensation table.

### DESCRIPTION OF THE EMBODIMENTS

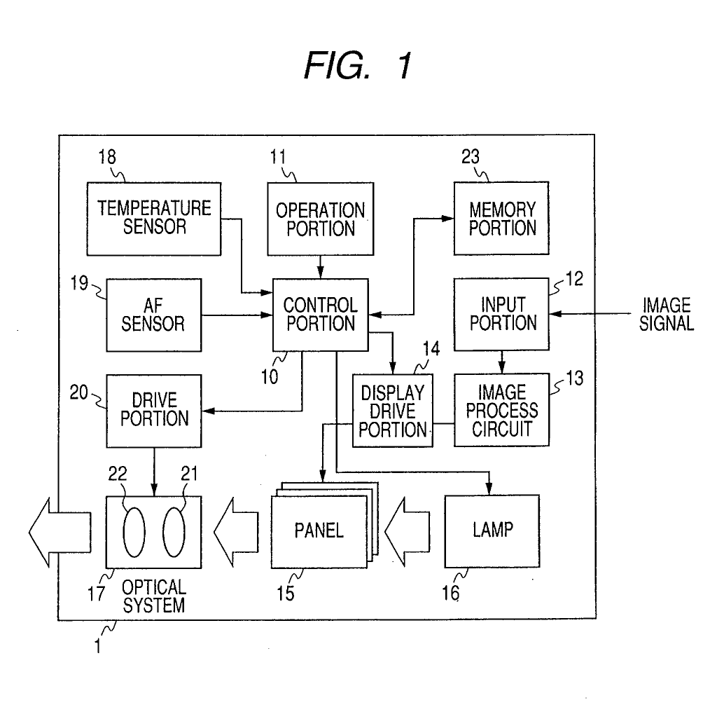

In the following, an embodiment of the present invention will be described with reference to the accompanying drawings. FIG. 1 shows the configuration of a liquid crystal projector (projection display apparatus). FIG. 1 illustrates a liquid crystal projector 1 which includes a control portion (control unit) 10, an operation portion 11, an input portion 12, an image processing circuit 13, a display drive portion 14, a liquid crystal panel (display unit) 15, a light source lamp 16, a projection lens system 17, a temperature sensor 18, an AF sensor (focus sensor) 19, a drive portion (drive unit) 20 and a memory portion (memory unit) 23. The control portion 10 is electrically connected with the operation portion 11, the display drive portion 14, the temperature sensor 18, the AF sensor 19, the drive portion 20 and the memory portion 23.

The operation potion 11 has a power switch for turning on/off the power and an AF switch for activating the AF operation. An image signal is input to the projector apparatus 1 through the input portion 12. The image signal input through the input portion 12 is input to the image processing circuit 13. The image signal is subjected to synchronizing separation by a decoder, and image signals R, G, B are generated. Digital processing such as color correction is performed on the image signals.

The display drive portion 14 is a timing generator that inputs drive signals associated with the image signals of the respective colors of R (red), G (green) and B (blue), on which tone correction has been performed, to the liquid crystal panel 15 to cause the liquid crystal panel 15 to display an image. The liquid crystal panel 15 displays images on which image processing has been performed corresponding to the respective colors of R, G and B. The liquid crystal panel 15 is illuminated by the light source lamp 16. The projection lens system 17 projects an image displayed on the liquid crystal panel 15 onto a screen. The projection lens system 17 is a zoom lens composed of a plurality of lens units 21, 22. The lens unit 22 is a focus lens that is moved for focusing.

The temperature sensor 18 is disposed in the vicinity of the AF sensor 19 to detect the temperature. The AF sensor 19 is adapted to output image data used to calculate the distance to a subject, that is in this case the distance to the projected image (or the screen), based on triangulation. The drive portion 20 drives the focus lens 22. The drive amount of the focus lens is calculated in the control portion 10 based on the image data supplied by the AF sensor 19. In the memory portion 23 are stored various setting data such as a temperature sensor compensation table used in compensating the output value of the temperature sensor.

The control portion 10 is a control circuit implemented in a micro computer that executes the above described processing. The control portion 10 turns on/off the power, controls auto focusing, performs illumination control including turning-on/off of the light source lamp 16 and measures the lapse time after activation of the apparatus, in response to operations of switches in the operation portion 11. Furthermore, the control portion 10 calculates a difference from image display timing and image data picked up by the AF sensor 19, compensates the temperature detected by the temperature sensor 18 and performs temperature compensation for the above-mentioned difference with reference to the content of the temperature sensor compensation table stored in the memory portion 23, and calculates distance information. Furthermore, it also calculates the target focus position for the focus lens 22 in the projection lens system 17 based on the aforementioned distance information, and controls the drive portion 20 to drive the focus lens 22 to the target position.

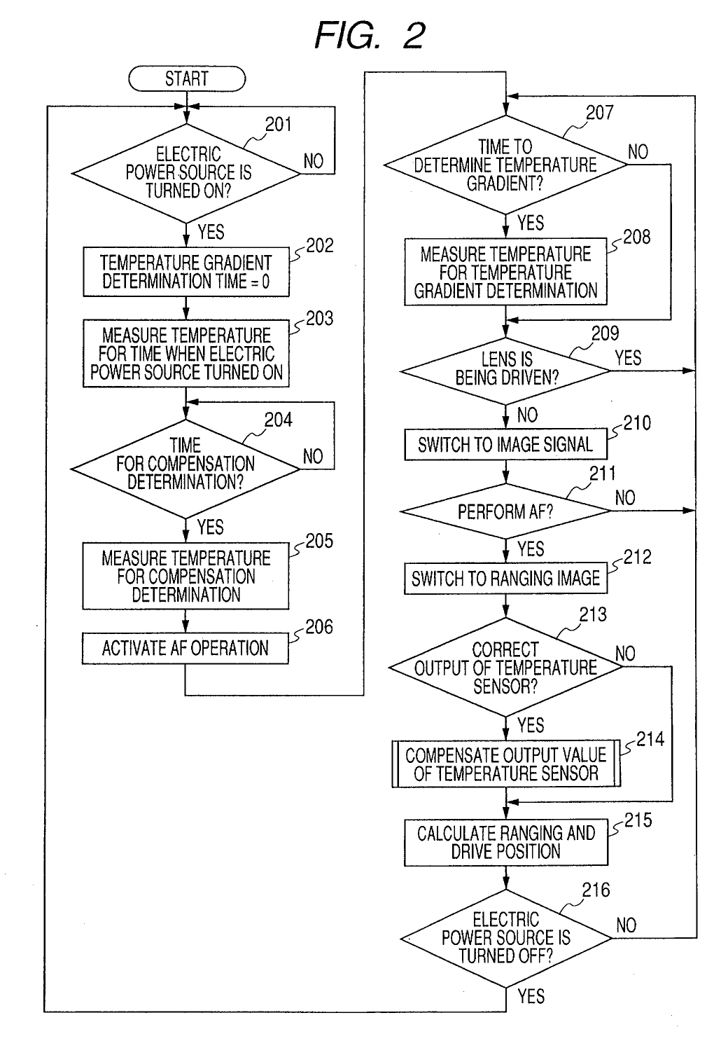

In the following, the AF operation in this embodiment will be described with reference to FIG. 2. First in step S201, the control portion 10 makes a determination as to whether the power key is operated or not repeatedly until the power key is operated. When the power key is operated, the control portion 10 sets temperature gradient determination time to be used in estimating the temperature gradient to zero in step S202. In step S203, the control portion 10 measures the temperature at the time when the power is turned on (at the time of activation) using the temperature sensor 18. Then in step S204, the control portion 10 waits until time to determine compensation (a first time). When the compensation determination time is reached, the control portion 10 measures compensation determination temperature at the compensation determination time using the temperature sensor 18, in step S205. In step S206, the control portion 10 enables the AF operation.

Then in step S207, the control portion 10 makes a determination as to whether the temperature gradient determination time is reached or not. When the temperature gradient determination time (second time) is reached, the control portion 10 measures temperature gradient determination temperature using the temperature sensor 18, in step S208. Otherwise, the process proceeds to step S209. In step S209, the control portion 10 makes a determination as to whether driving of the focus lens 22 has been completed or not. When the lens is still being driven, the process of the control portion 10 returns back to step S207 and waits until the lens becomes stationary. When the lens is stationary, the control portion 10 switches the projected image to the image signal externally input into the projector apparatus 1, in step S210. In the case where the image signal has been previously projected, the projection is left unchanged.

In step S211, the control portion 10 makes a determination as to whether the AF operation is performed through the operation portion 11 or not. When the operation is not performed, the process returns back to step S207. On the other hand, when the AF operation is activated by entry through the operation portion 11, the process proceeds to step S212. In step S212, the control portion 10 switches the projected image to an image for ranging. In step S213, the control portion 10 makes a determination as to whether the output of the temperature sensor is to be compensated or not, in other words, whether or not the light source lamp 16 was turned on before it had cooled sufficiently. When compensation is to be performed, the control portion 10 compensates the output value of the temperature sensor, in step S214. In step S215, the control portion 10 calculates a difference from the output values of the AF sensor 19, and performs temperature compensation on the aforementioned difference based on the compensated temperature determined by compensating the output value of the temperature sensor in step S214, and calculates distance information. Then, the control portion 10 calculates the lens position based on the calculated distance, and causes the drive portion 20 to drive the focus lens 22. In step S216, the control portion 10 makes a determination as to whether an operation for turning off the power is performed or not. When the operation is performed, the control portion 10 turns off the light source lamp 16, and the process returns to step S201, while when the operation for turning off the power is not performed, the process returns to step S207.

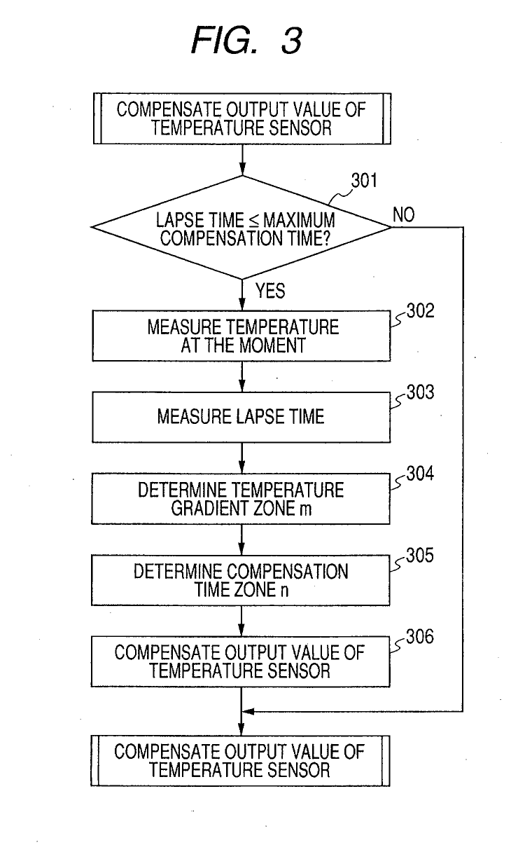

In the following, compensation of the output value of the temperature sensor in this embodiment will be described with reference to FIG. 3. First in step S301, the control portion 10 makes a determination as to whether the time elapsed since activation of the apparatus is shorter than the maximum compensation time (third time) or not. If the maximum compensation time has elapsed, the control portion 10 terminates the process without compensating the output value of the temperature sensor. In the case where the output of the temperature sensor is to be compensated, the control portion 10 measures the current temperature at that time using the temperature sensor 18, in step S302. In step S303, the control portion 10 measures the time elapsed since activation of the apparatus. Then in step S304, the control portion 10 determines a temperature gradient zone m in the temperature sensor compensation table based on the temperature difference between the temperature sensor output obtained in step S302 and the temperature sensor output at the temperature gradient determination time.

In step S305, the control portion 10 determines a compensation time zone n based on the time elapsed since activation of the apparatus. In step S306, the control portion 10 determines a compensation value v from the temperature sensor compensation table (FIG. 6) stored in the memory portion 23 based on the temperature gradient zone m and the compensation time zone n, and compensates the temperature sensor output value by the compensation value v.

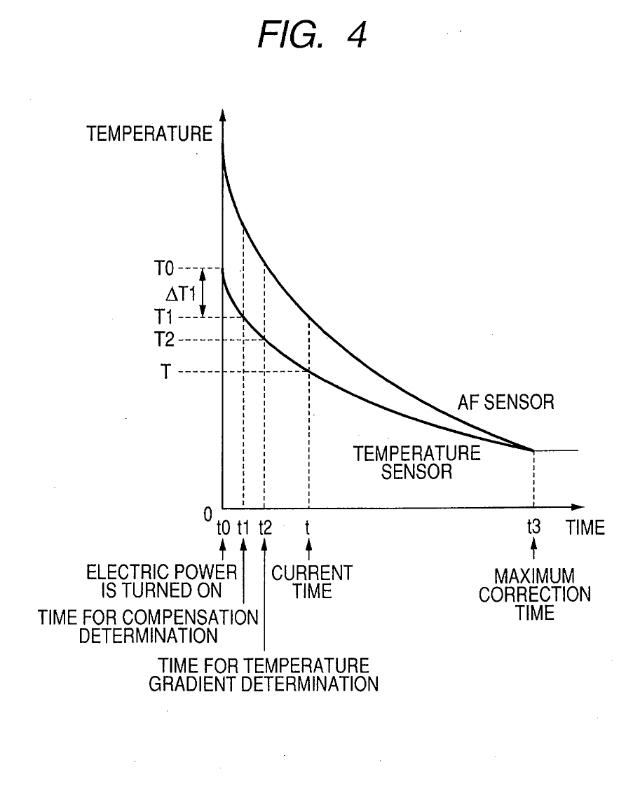

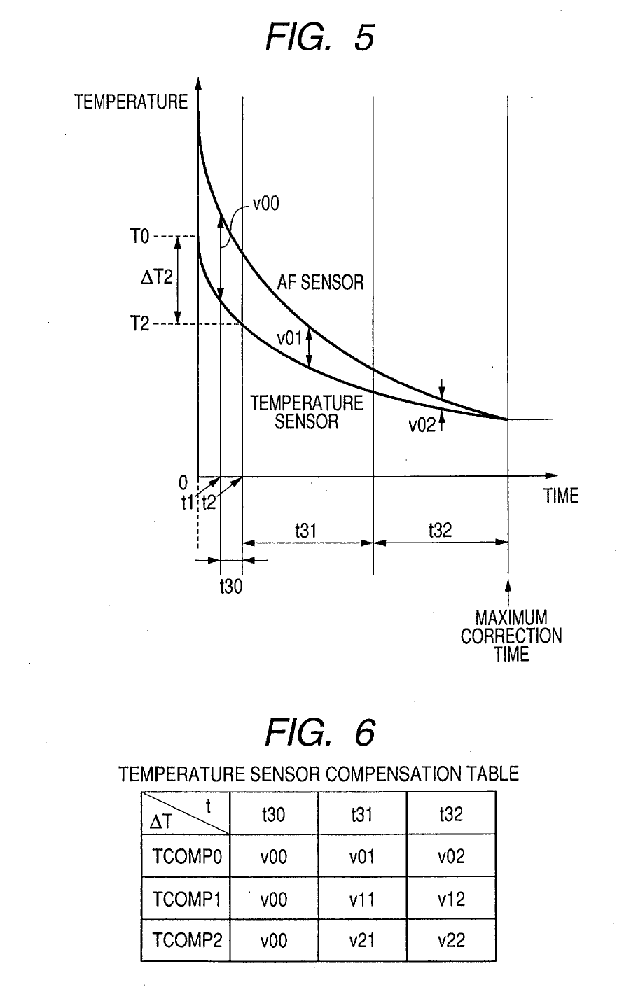

Next, a method of compensating the output value of the temperature sensor will be described with reference to FIGS. 4, 5 and 6. In liquid crystal projectors 1 in general, when the power is turned off, the light source lamp 16 is turned off and the cooling fan is stopped after a while. This means that the fan is stopped before heat of the light source lamp 16 is completely removed. Accordingly, the heat generated by the light source lamp 16 remains in the interior of the cabinet for a while after the fan is stopped. Consequently, the temperature of the electric parts becomes higher than that during the time in which the power is on or the lamp is on. When the power is turned on again, in other words, when the lamp is turned on again, the fan starts to rotate, and the heat remaining in the cabinet is removed in a short time. Then, the temperature of the electric parts also falls rapidly. How the temperature falls varies depending on the initial temperature. For this reason, when there is a difference between the initial temperature of the AF sensor 19 and the initial temperature of the temperature sensor 18, the temperature relationship cannot be determined for a certain period of time after the power is turned on in some cases, as shown in FIG. 5.

In view of this, in this embodiment, the output value of the temperature sensor 18 is compensated for a certain period of time during which relationship between the temperature of the AF sensor 19 and the temperature of the temperature sensor 18 cannot be determined, namely until the maximum correction time is reached. In determining the compensation value, several hypothetical temperature gradient zones (for example, three temperature gradient zones TCOMP 0, TCOMP 1 and TCOMP 2 each of which is labeled representing the smallest temperature gradient within the respective temperature gradient zones that have relation as follows, TCOMP 0>TCOMP 1>TCOMP 2) of the AF sensor and the temperature sensor are used, since the initial temperature differs depending on the time elapsed from the latest turning-off of the power until the turning-on. As shown in FIGS. 4 and 5, a determination is made as to whether the output value of the temperature sensor 18 is to be compensated or not based on the amount of change in the output value of the temperature sensor (ΔT1=T0−T1) from the time t0 at which the power is turned on to the temperature compensation determination time t1. In the case where the amount of change for compensation determination is assumed to be TCOMP 2, when ΔT1>TCOMP 2, namely when the temperature falls by a value equal to or larger than a predetermined value, it is considered that the power was turned on before sufficient cooling, and compensation is performed.

When compensation is to be performed, based on the amount of change in the output value of the temperature sensor (ΔT2=T0−T2) from the time t0 at which the power is turned on to the temperature gradient determination time t2, a temperature gradient zone m of the AF sensor 19 and the temperature sensor 18 after the temperature gradient determination time t2 is determined in order to determine the temperature gradient of the AF sensor 19. Next, the time after that until the maximum compensation time t3 is divide into several time zones (in FIG. 5, three zones t30, t31 and t32), and a compensation time zone n is determined based on the time elapsed since activation of the apparatus. Then, the temperature sensor output value is compensated by values (in FIG. 5 v00, v01, v02) associated with m and n as follows, the values corresponding to the temperature differences between the AF sensor 19 and the temperature sensor 18.

T′=T+Vmn, where T′ represents the output value of the temperature sensor after compensation, T represents the output value of the temperature sensor before compensation, Vmn represents the compensation value in the temperature gradient zone m and the compensation time zone n.

For example, if TCOMP 2>ΔT2>TCOMP 1, namely ΔT2 is within the temperature gradient zone TCOMP 1, and the time t elapsed after activation is within the time zone t31, then m=1 and n=1. Thus, the temperature sensor output T at that time t is compensated as follows.

T′=T+v11

If t1<t<t2, the temperature T2 at the temperature gradient determination time t2 has not been measured yet, that is, T2=0, the compensation value is determined by setting m=0 and n=0. Consequently, the temperature sensor output T is compensated as follows.

T′=T+v00

In this way, in the range t1<t<t2 in which the temperature gradient cannot be estimated, the value is fixed value v00. The memory portion 23 stores a temperature sensor compensation table as shown in FIG. 6 that contains the above described compensation values. The control portion 10 fetches the temperature sensor compensation table from the memory portion 23 and performs the above described temperature sensor compensation.

The compensation values in the temperature sensor compensation table are determined from the averaged value in each compensation time zone based on the temperature gradients of the AF sensor 19 and the temperature sensor 18 obtained experimentally, and stored in the memory portion 23. Thus, it is possible to determine the temperature of the AF sensor 19 almost correctly under any circumstance, and accordingly it is possible to reduce an error in ranging. Consequently, successful auto-focusing is ensured irrespective of the circumstance of usage.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-032688, filed Feb. 9, 2006, which is hereby incorporated by reference herein in its entirety.

What is claimed is:

1. A projection display apparatus comprising:
a projection lens that projects an image, the projection lens including a focus lens that moves for focusing;
a focus sensor;
a temperature sensor; and
a control unit electrically connected with the focus sensor and the temperature sensor, the control unit driving the focus lens using outputs from the focus sensor and the temperature sensor,
wherein the control unit compensates the output value of the temperature sensor according to the amount of change in the output value of the temperature sensor with lapse time, and drives the focus lens using the value thus compensated.

2. A projection display apparatus according to claim 1, wherein the control unit makes a determination as to whether compensation of the output value of the temperature sensor is to be performed or not based on the difference between the output value of the temperature sensor at the time of activation of the projection display apparatus and the output value of the temperature sensor at a first time after the activation.

3. A projection display apparatus according to claim 2, wherein the control unit determines a compensation value based on the difference between the output value of the temperature sensor at the time of activation of the projection display apparatus and the output value of the temperature sensor at a second time later than the first time.

4. A projection display apparatus according to claim 3, wherein the control unit changes the compensation value according to time elapsed since the activation of the projection display apparatus.

5. A projection display apparatus according to claim 3, wherein the control unit compensates the output value of the temperature sensor when time lapsed since the activation of the projection display apparatus is shorter than a time until a third time that is later than the second time.
